(19) United States
(12) Patent Application Publication
(10) Pub. No.: US 2010/0323834 A1
(43) Pub. Date: Dec. 23, 2010

(54) CENTRIFUGAL CLUTCH TIMING BELT POWER TRANSMISSION CONTROL SYSTEM FOR A SMALL GASOLINE ENGINE

(76) Inventor: Donald Barton Grube, Bokchito, OK (US)

Correspondence Address: CBM PATENT CONSULTING, 12462 OLIVER CROMWELL DR., HERNDON, VA, 20171-2517, US

(21) Appl. No.: 12/792,848

(22) Filed: Jun. 3, 2010

Related U.S. Application Data
(60) Provisional application No. 61/219,461, filed on Jun. 23, 2009.

(51) Int. Cl. F16H 7/02; F16H 57/02

(52) U.S. Cl. 474/144

(57) ABSTRACT

A T belt power control system is disclosed to consist of a centrifugal clutch integral bell drum, or in the case of a straight shaft engine such as a Honda GXH50 a non integral bell drum, a T belt drive pulley affixed to a bell drum, an automotive type timing belt, a driven pulley cylindrical cam lock assembly consisting of a larger driven pulley with a one-way bearing for speed reduction and torque enhancement, a non concentric cylindrical housing and an output jackshaft with or without an engine power engaging system to a primary drive sprocket for chain operation. The T Belt tension is secured and maintained by rotating the cam lock assembly with a spanner wrench and then held tight by four bolts. If the T belt power control system is made without an engager system the power is transmitted as soon as the centrifugal clutch latches with the bell drum. If with an engager system the engagement and disengagement of engine power is done by an integral engager remotely controlled by steel cable and hand lever. A motorized vehicle is disclosed as consisting of a standard bicycle frame or modified bicycle frame, a tricycle frame, a go-cart frame, and a paddle wheel boat frame all with the T belt power control system of present invention installed on a gasoline four cycle engine.

### TECHNICAL FIELD OF THE INVENTION

This invention relates to a gasoline internal combustion four-cycle engine power-assisted vehicle, in which a horizontal shaft engine is utilized to self propel a vehicle, particularly but not exclusively a bicycle, a tricycle, a go-cart, a paddle boat and similar vehicles, and to its application being extended to a stationary engine work station utilized to chain drive a work wheel or driven axle requirement.

### BACKGROUND OF THE INVENTION

In developed countries, bicycling and pedal boating are enjoying preferred outdoor activities by many people, both are pleasant and healthful exercises. Riding a bicycle to work employment short distance locations is environmentally friendly transportation and less expensive than commuting by car, SUV or pickup truck using high fuel consumption. Therefore, it is not surprising that bicycles, tricycles, go-carts are utilized as dominant means of transportation in developing countries especially in rural and remote areas and represent a market challenge for motorizing said vehicles. Light weight vehicles such as a motorized bicycle have a niche market place below that of motorcycles and commercial mopeds. Even in developed countries that are experiencing high fuel cost alternative modes of transportation is becoming increasing popular such as bicycles, mopeds, scooters, and motorcycles.

Conventional vehicles such as bicycles, tricycles, go-carts and paddle boats are limited by their human-power abilities. Some people cannot pedal a bicycle, tricycle or go-cart while others become tired easily especially in mountainous or hilly areas. It is difficult to pedal a paddle wheel boat for long distance or up stream in a rapid flowing stream that might also be dangerous to such users.

Several variations of basic motorized bicycle gasoline engine kits have been developed for end users in the prior art. Some of these engine kits incorporate two-cycle gasoline engines using oil/gasoline mixture that have high exhaust air pollution resulting from mixing oil and gasoline in combustion. Most of these 2 cycle type engines have been imported from China. Other prior art motorized bikes incorporate rudimentary exposed belt or chain drives with engines mostly mounted over the rear wheel or inside the frame and without any way to mechanically disengage engine power at rpm above clutch operation without killing the engine. Prior art includes a related U.S. patent application Ser. No. 11/428,539 invented by Donald Barton Grube who is the same inventor on record as with this T Belt power transmission control system.

There exists some electric motor-based bicycles but they have limited low power for hill-climbing and the inability to recharge batteries away from electrical outlets. Gas stations remain the most prevalent present source for vehicle refueling in the USA. The design of an end user specialized engine kit to motorize a standard V frame bicycle and also meet EPA regulation for gasoline engine emission in the prior art are too complex to manufacture due to the obligation for an exclusive EPA approved engine not yet available on the market to replace two-cycle engine bicycle kit variants. The present invention utilizes a standard four-cycle gasoline engine already approved by EPA and readily available in the Original Equipment Manufacture known as OEM, dealer aftermarket. Such newly designed high rpm engines are now made in cc displacement below 50 cc where by making them legal to use on motorized bicycles for on road use in many states in USA.

The present invention provides an end user a way to motorize a vehicle by using a standard EPA approved easily obtainable aftermarket high rpm four-cycle gasoline engine without any modification. As further recognized by the present invention, it is an accoutrement apparatus component that enables the end user to apply a small four-cycle gasoline engine to a chain drive work related wheel type load requirement and gain gear reduction speed and torque with the benefit of engine power engagement control. The object of this present invention is to provide a power control transmission system to motorize a vehicle by utilizing a centrifugal clutch and an automotive engine type rubber timing gear belt to transmit torque from the centrifugal clutch pulley to a larger driven pulley and on to an output shaft. Said timing belt has tension adjusted by a rotating a non concentric cam pulley housing thus gaining the advantage of safety and complete control of engine engagement without the clumsy addition of a belt slack adjuster. Another object of the present invention is to provide a practical way to drive a work related wheel or axle load requirement, but not exclusively limited to, motorizing bicycles, motorizing tricycles, motorizing paddle wheel boats, and motorizing pedal go carts for on road or off road use.

### SUMMARY OF THE INVENTION

A motorized vehicle is disclosed by typical exemplification that includes a standard bicycle V frame or a modified bicycle V frame having a front wheel and a rear wheel attached thereto and a seat for people pedaling a chain wheel sprocket. A small four-cycle gasoline engine with displacement from 30 cc to 80 cc is mounted in the middle of the bicycle V frame or can be mounted over the rear wheel. The invention is disclosed as a centrifugal clutch timing belt power transmission Control System, hereafter referred to simply as the T Belt Power Control System.

Centrifugal Clutch in this invention is defined as a devise consisting of Rotor and Bell Drum. Abbreviations CC in this document here-after refer to Centrifugal Clutch. OEM CC abbreviation means Original Equipment Manufacture Centrifugal Clutch supplied integral with engine. The CC rotor consist of three padded shoes attached to springs that are able to expand outwardly in a CCW circular motion when subjected to RPM great enough to overcome their static position. The rotor is affixed on the end of engine crankshaft. Latch speed is that RPM when the three Rotor shoes are able to expand sufficiently to engage the bell drum ID and transmit engine torque from the crankshaft. The CC bell drum with drive pulley is described as a steel cup shaped devise on a shaft supported by ball bearings or can be an oil impregnated bronze bushing commonly called Oil Lite in the mechanical trade; Said bell drum and drive pulley are considered part of the T Belt Power Control System invention when made integral with the housing bracket like when used with a four cycle engine having the centrifugal clutch rotor supplied with the engine. If not made integral as would be required on some engines such as with a Honda GXH50 the bell drum and drive pulley would not be considered as part of said invention but none the less important in the operation of said invention.

Timing Gear Belt defined as same as used in existing automotive engine state of the art for the purpose of valve train operation. Said timing gear belt in some manufactures text is referred to as a “Synchronous T type Belt”. The belt used in this invention is a standard rubber timing belt available in different lengths to work with driven pulleys from 100 T to 80 T diameters.

Moped defined: A small four-cycle gasoline engine from 30 cc to 150 cc displacement is mounted in the middle of a bicycle V frame like found on 24 to 26″ beach cruiser bikes or the engine can be mounted over the rear wheel on a hold rack. The T belt power control system having a centrifugal clutch bell drum with drive pulley supported on a ball bearing shaft made integral with support plate housing is installed on said four cycle engine output shaft having a three centrifugal shoe rotor and working in conjunction with a T Belt to a step down ratio large driven pulley. The T belt power control system may optionally include an integral engager system or may be used without an engager system. The T Belt power control assembly is attached to an engine accessory drive mounting flange with four bolts. A drive chain attaches to the output jackshaft of the T belt power control system via a small primary drive sprocket and goes to a much larger sprocket mounted on the rear axle of a standard 24″ to 26″ bicycle. This application is commonly referred to as a moped because it can be pedaled with engine off or operated with engine running.

A motorized vehicle is further disclosed that includes a tricycle frame, commonly refer to as a Rickshaw or a modified or standard tricycle frame having a front wheel and two rear wheels attached thereto and a seat for people pedaling a chain wheel sprocket. A small four-cycle gasoline engine from 30 cc to 150 cc displacement is mounted in the middle of the rickshaw or tricycle V frame. The T belt power control system having a centrifugal clutch bell drum with drive pulley supported on a ball bearing shaft made integral with support plate housing is installed on a four cycle engine output shaft having a three centrifugal shoe rotor and working in conjunction with a T Belt to a step down ratio large driven pulley. The T belt power control system may optionally include an integral engager system or may be used without an engager system. The T Belt power control assembly is attached to an engine accessory drive mounting flange with four bolts. A drive chain attaches to the output jackshaft of the T belt power control system via a small primary drive sprocket and goes to a much larger sprocket mounted on the rear axel of the tricycle.

Moped function referred to above incorporates using a gasoline four cycle engine that can be pedal started, electric started or rope pull started and then powers the driven bicycle wheel to propel the riders. The driven wheel can be operated in different modes with engine on or off.

i) engine off mode: By leaving the engager of the power control system in the open position a driven wheel can freewheel coast or be driven by other means as with a people powered pedal sprocket; ii) engine on mode: With the gasoline engine running and the power control system jackshaft engager in the closed or engaged position, engine power is converted in a step down speed ratio enhancement. iii) operator control: Operator has full control to engage power or to disengage engine power at any time thus gaining an important safety and engagement enhancement advantage; iv) Engine running with engager in the open position allows for carburetor adjustments at high engine rpm without the driven work wheel turning.

As used in a moped should the power control system be made without an optional engager system the work load wheel will immediately turn if engine RPM is sufficient to latch the Centrifugal clutch rotor to the bell drum and safety can be compermised.

A motorized vehicle is further disclosed that includes a paddle boat normally found as a personal pleasure small boat incorporating one to four people seats. A small four-cycle gasoline engine is mounted to the boat framework. The small four-cycle gasoline engine from 30 cc to 200 cc displacement is mounted in the boat framework. The T belt power control assembly having a centrifugal clutch bell drum with shaft drive primary drive pulley installed as an assembly on a engine output shaft having a three centrifugal shoe rotor and working in conjunction with T Belt power transmission to optionally include an integral engager system. The T Belt power control assembly is attached to an engine accessory drive mounting flange with four bolts. A drive chain attaches to the output jackshaft of the T belt power control system via a small primary drive sprocket and goes to a much larger sprocket mounted on the boat paddle wheel shaft.

A motorized vehicle is further disclosed as being a go-cart having four wheels on two axels, a steering wheel and seat for the operator and or passenger. A go-cart may be in many configurations and work applications to include light cargo hauling or for people transportation. A small gasoline engine is mounted to the go cart frame. A small four cycle gasoline engine from 30 cc to 200 cc displacement is mounted in the go-cart framework. The T belt power control assembly having a centrifugal clutch bell drum with shaft drive primary drive pulley installed as an assembly on a engine output shaft having a three centrifugal shoe rotor and working in conjunction with a T Belt power transmission to optionally include an integral engager system. The T Belt power control assembly is attached to an engine accessory drive mounting flange with four bolts. A drive chain attaches to the output jackshaft of the T belt power control system via a small primary drive sprocket and goes to a much larger sprocket mounted on the rear axel of the go-cart.

A stationary engine work station can be further disclosed as work station requiring small four-cycle engine to turn an axel shaft such as would be typicality found using a circle saw to cut wood but not exclusively. A small four-cycle gasoline engine from 30 cc to 200 cc displacement is mounted on the work station frame. The T belt power control assembly having a centrifugal clutch bell drum with shaft drive primary drive pulley installed as an assembly on a engine output shaft having a centrifugal shoe rotor 3 and working in conjunction with a T Belt power transmission to optionally include an integral engager system. The T Belt power control assembly is attached to an engine accessory drive mounting flange with four bolts. A drive chain attaches to the output jackshaft of the T belt power control assembly via a small primary drive sprocket and goes to a much larger sprocket mounted on the rear axel of the intended work load requirement such as an grain elevator or wood cutting saw but not exclusively.

To be able to use an off the shelf aftermarket EPA approved high tech four-cycle small gasoline engine of normally 30 cc to 200 cc displacement, but not limited to, said displacement for applications requiring a driven wheel to do work with a reduced ratio speed, thus gaining torque enhancement ratio and have complete control with an engager system that is remote controlled by steel cable and lever. Such applications can be, but not exclusively limited to, motorizing bicycles, tricycles, paddle boats, and pedal go carts. Engine running with engager in the open position or disengaged position allows for high rpm engine operation without the driven work wheel turning as such would be needed when setting carburetor adjustments for correct air fuel mixture. Said engager system is covered by U.S. Pat. No. 7,591,202 in a gear box arrangement belonging to this inventor.

### BRIEF DESCRIPTION OF THE DRAWINGS

The present invention will be understood more fully from the detailed description of the preferred embodiments given below, from the appended claims and from the accompanying drawings. The description of specific embodiments are used to explain and understand the invention, should not be taken to limit the scope of the invention.

FIG. 1 is a typical exemplification of the invention denoted as TBPCS as would be applied on an engine in a bicycle frame. Other applications that could be utilized would work in the same manner as on a bicycle. FIG. 1 shows the TBPCS application with and without an engager system.

FIG. 7 Cover on and FIG. 8 Cover off; Shows the T Belt power control system installed on a typical 4 cycle small engine with Centrifugal clutch.

FIG. 2 shows the preferred embodiments collect in one Figure. The Centrifugal Clutch shown as 12. Driven pulley 6 with a one-way ball bearing and sprag clutch 35. Drive Timing Belt 29; the non concentric cam lock 4 for Pulley 6 on a jackshaft which serves as a way to tighten said drive timing belt 29 without using an idler pulley of any kind. A spanner wrench 29 is used to rotate the cam lock 11. The spanner wrench is stored on or about the donor vehicle or the applied machine for use as required.

FIG. 3 shows invention as an assembly exploded view with a belt guard safety cover 36 going over the timing belt and held securely with three brackets and bolts.

The belt tension is adjusted by rotating the cam lock 4 or 4-1 with a spanner wrench 20 as shown in FIG. 3. When the T belt is tight four bolts secure the pulley cam lock assembly to the power control system transmission plate 1 or 1-1.

FIG. 4 is a Section AA showing the invention without an engager system and in two variations: One is for engines with a built in centrifugal clutch on the end of crankshaft and one for straight shaft engines having no included centrifugal clutch. The T belt power control assembly parts consists of steel or aluminum plate 1 or 1-1, Bell drum 2 or 32, a drive pulley 3 or 32 and a cylindrical cam lock assembly 4, 4-1 or 4-2, Timing belt 29 and jackshaft 5,5A,or 15B riding on two ball bearings. FIG. 4. shows the T belt power control system can also work on a straight shaft engine having a three shoe rotor and bell drum with pulley both affixed to the end of the crankshaft. In this case the bell drum rides on a bronze bushing instead of affixed to a ball bearing supported shaft as with the integral version. This type centrifugal clutch system operation is also described in the inventor's patent U.S. Pat. No. 7,591,202 and is used on engines like the Honda GXH 50 or 142F HuaSheng horizontal straight shaft engines having a threaded hole and key way.

FIG. 5 is the invention with an engager system and also shown exploded in FIG. 12. The purpose of and use of an engager system is covered under U.S. patent application Ser. No. 11/428,539 and final patent U.S. Pat. No. 7,591,202. The engager system is located in the pulley cam lock housing assembly and controlled by a handle bar lever and cable.

FIG. 6 shows a typical state of the art four cycle vertical cylinder horizontal output shaft CCW rotation engine having a three-pole shoe rotor affixed to the crankshaft and latching with a bell and drive pulley affixed to the end of the engine crankshaft. FIG. 6 shows the output shaft center lines called out as CL and the four bolt accessory drive mount flange threaded holes 25 for attaching the T belt power control system 1.

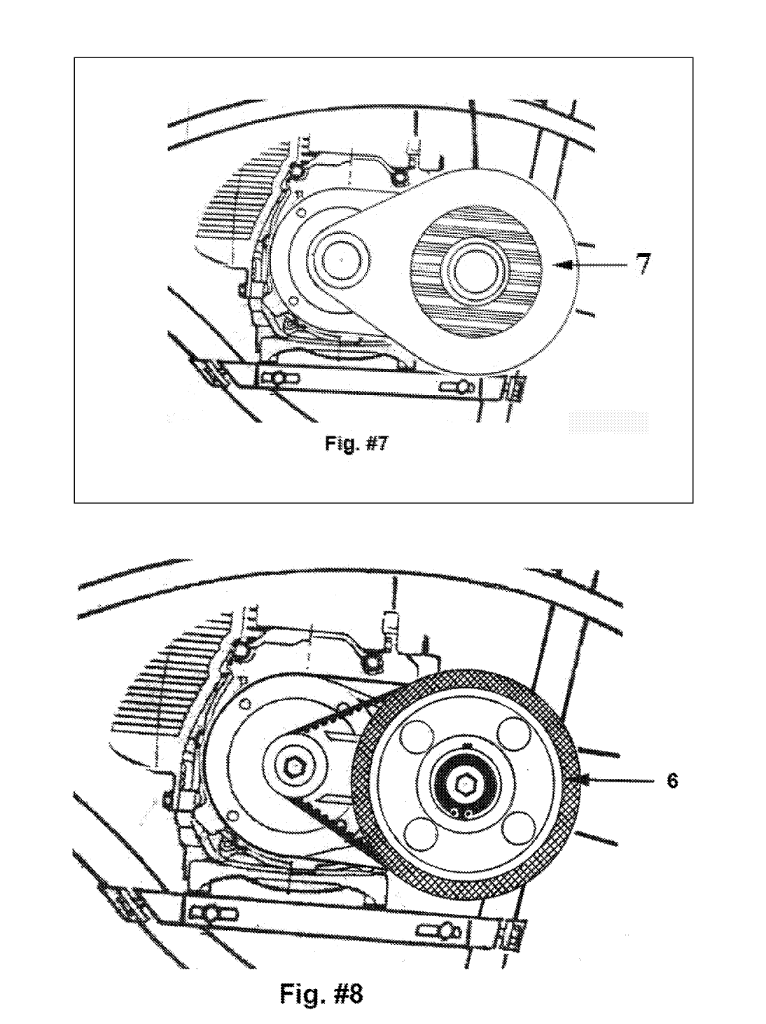

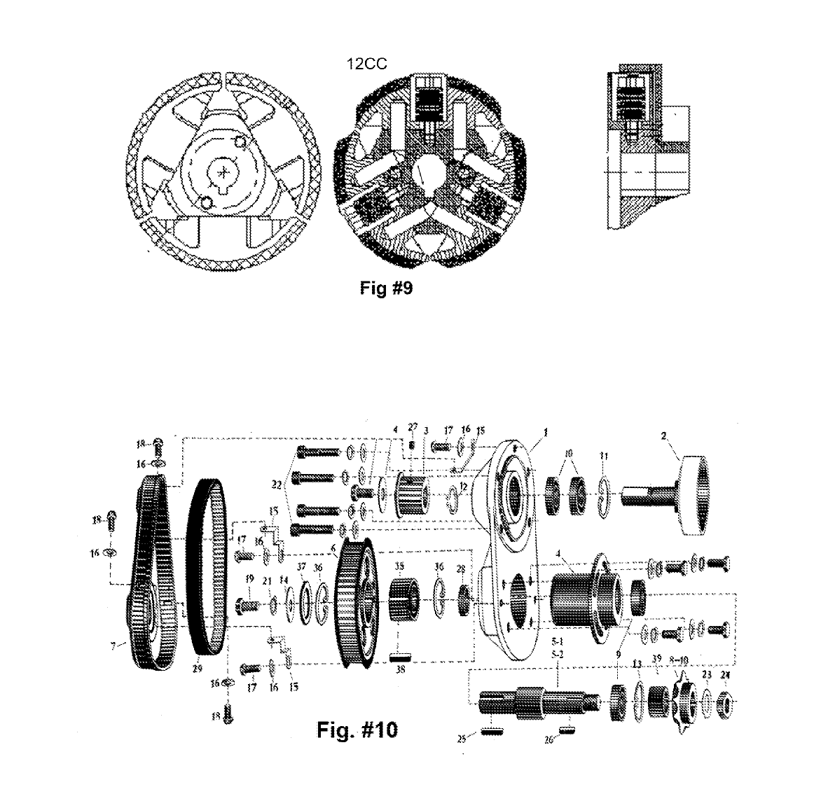

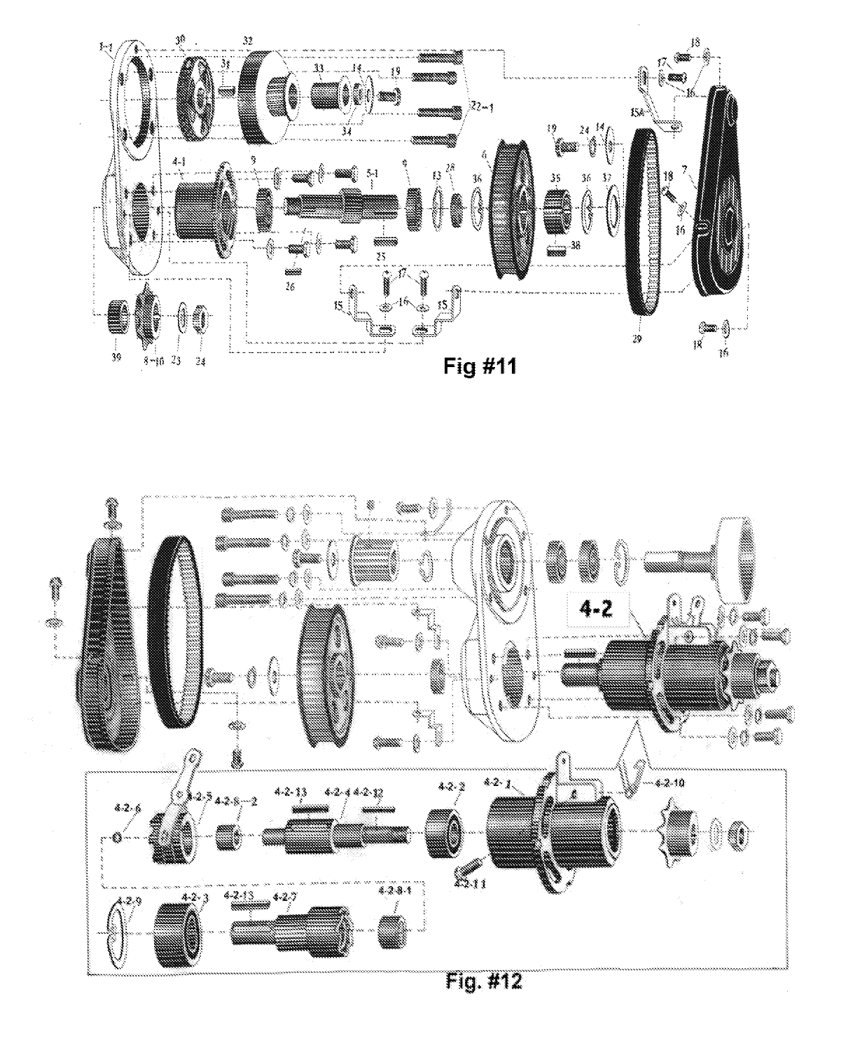

FIG. 7 Shows a typical four cycle engine with said invention installed and cover guard 7 in place.

FIG. 8 Shows said invention with cover guard 36 removed thus revealing the T Belt drive train going to driven pulley 6. FIG. 7 Cover on and FIG. 8 Cover off; Shows the T Belt power control system installed on a typical four cycle small engine with Centrifugal clutch.

FIG. 9 shows a typical shoe centrifugal clutch rotor 3 12CC which may or may not come with the engine depending on make and model.

FIG. 10 shows the parts of a T belt power control transmission applicable for an engine with a Centrifugal Clutch (CC) supplied integral with engine.

FIG. 11 shows the parts of a T belt power control transmission applicable for an engine with a straight shaft without a Centrifugal Clutch (CC).

FIG. 12 shows the parts of a T belt power control transmission with engager applicable for an engine with an integral Centrifugal Clutch (CC) supplied with engine.

### DETAILED DESCRIPTION OF THE PREFERRED EMBODIMENTS

### EXAMPLE 1

A motorized bicycle is disclosed as an exemplification that includes a standard bicycle V frame or a modified bicycle V frame having a front wheel and a rear wheel attached thereto and a seat for people pedaling a chain wheel sprocket. A small four-cycle gasoline engine with displacement from 30 cc to 80 cc is mounted in the middle of the bicycle V frame. The invention is disclosed as a centrifugal clutch timing belt power transmission control system, hereafter referred to as T belt power control system. The T Belt power control system having a prior art counterclockwise rotational, three-shoe centrifugal clutch rotor installed on a engine output crankshaft and working in conjunction with said invention. The T belt power control assembly is attached to an engine's four-bolt accessory drive mounting flange. A drive chain attaches to an output jackshaft of the T belt power control system via a small primary drive sprocket and goes to a much larger sprocket mounted on the left side of the rear wheel.

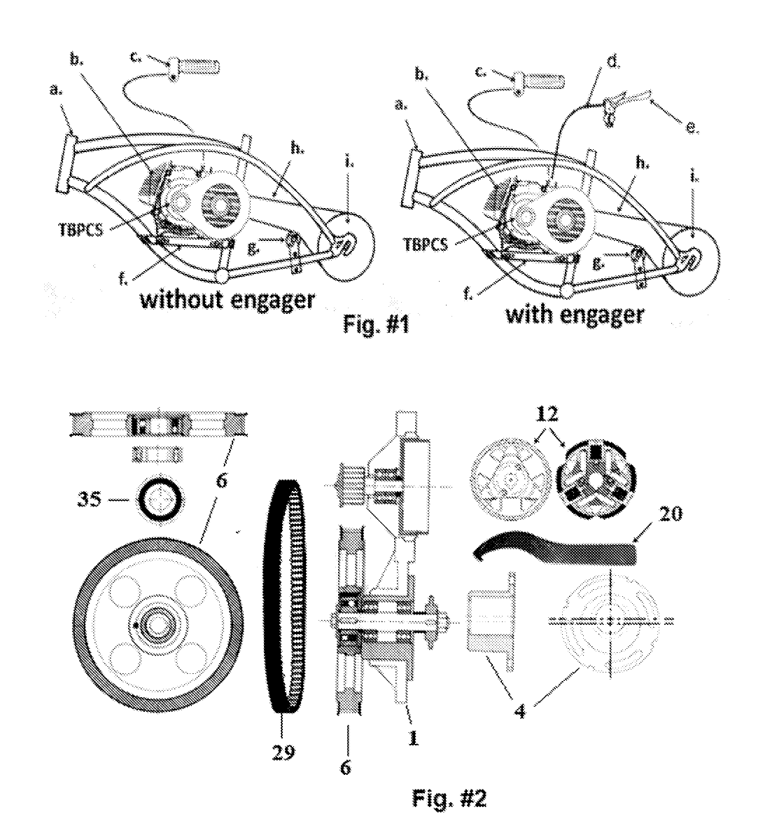

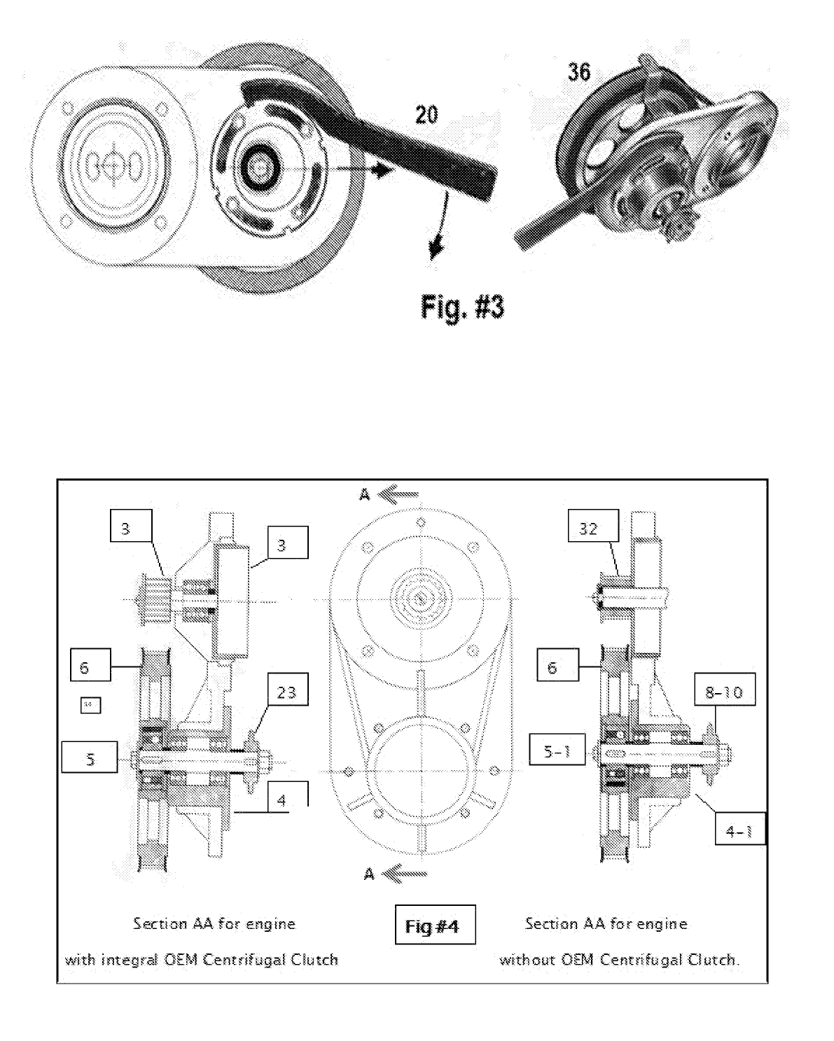

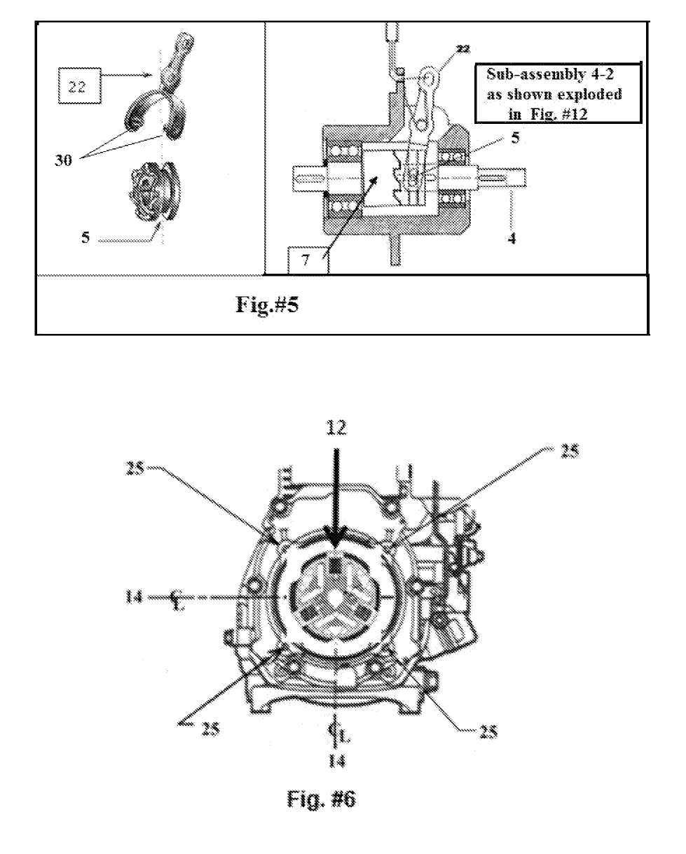

The drawings of FIGS. 1 through 12 are used to interpret the present invention with specification description but not used to limit the scope of the invention.

FIG. 1. is a typical state of the art bicycle frame such as may be used to hold a small four cycle engine b on a slide adjustable bracket f whereby an end user could attach a T belt power control system (TBPCS) to said engine. The T Belt power control system is held together by a housing plate as an integral assembly. FIG. 1. also shows with and without an engager system cable and hand lever.

FIG. 2 shows the important embodiment parts; Driven pulley with a one-way bearing, Timing belt, and a non concentric Cam Lock for belt tightening.

FIG. 3 shows an isometric view and 2D view of the T Belt power control system and how a spanner wrench is used to tighten belt tension by rotating the non concentric Cam Lock.

FIG. 4. Let it be noted that 12CC in FIG. 9 is not part of this invention but is require to work in concert by latching with a bell drum rotor 3 or 32 thus driving a small drive pulley that in conjunction with a T belt can drive a larger pulley 6 attached to shaft 5 or 5-1 riding on two-ball bearings. FIG. 4 Shows the drum bells 3 and 32 required in this invention as well as the chain drive sprocket 8-10 which can be supplied in various number of sprocket teeth from ten to eleven.

FIG. 5 is a section view of a cam lock sub-assembly 4-2 as required to work with a shift lever operated engager system as described in U.S. Pat. No. 7,591,202,B2. FIG. 5 shows the sliding engagement gear 5 and shift lever 22 with forked arms having two buttons 30 made of hardened grade steel that ride in a grooved slot in the peripheral diameter of the engagement gear 5. This is an alternative design: Shift Lever buttons comprises one way to move the sliding engagement gear 21.

FIG. 6 shows a typical state of the art four cycle vertical cylinder horizontal output shaft CCW rotation engine having a three-pole shoe rotor affixed to the crankshaft and latching with a bell and drive pulley affixed to the end of the engine crankshaft. FIG. 6 shows a typical small four cycle vertical cylinder horizontal output shaft CCW rotation engine used with said invention. FIG. 7 shows the output shaft center lines called out as CL and the four bolt accessory drive mount flange threaded holes 25 for attaching the T belt power control system, TBPCS.

FIG. 7 Shows a typical four cycle engine with said invention installed and cover guard 7 in place.

FIG. 8 Shows said invention with cover guard 36 removed thus revealing the T Belt drive train going to driven pulley 6.

FIG. 9 A prior state of the art three-shoe centrifugal clutch rotor #12CC which can be part of a four-cycle engine integral or an aftermarket add part to an engine having a straight shaft.

FIG. 10 shows the parts of a T belt power control transmission applicable for an engine with an integral Centrifugal Clutch (CC) supplied with engine as OEM. The items shown in exploded view FIG. 10 consist of the following reference numbers and descriptions: Housing bracket 1, Centrifugal clutch bell and shaft 2, 3. Drive pulley 3, Pulley cam housing 4, jackshaft 5, Driven Pulley 6 with one-way bearing, Plastic cover guard 7, Chain sprocket 8, Ball bearing 9, Ball bearing 10, Ball bearing 11, Snap ring retainer 12, Snap ring retainer 13, Flat washer 14, Bracket arm to hold plastic cover guard 15 (set of three), Washer 16, Screw 17 attached by bracket, Screw cover attach 18, Bolt 19 attached by pulley, Flat washer 20, Lock washer 21, Transmission attach bolt, set of four 22, Washer 23, Nut for sprocket 24, Key for driven pulley 25, Key for chain sprocket 26, Set screw for drive pulley 27, Spacer for pulley 28, Drive T Belt 29, One-way bearing for driven pulley 35, Snap ring retainer 36, Spacer ring 37, 38. Key 38, Spacer for chain sprocket 39.

FIG. 11 shows the parts of a T belt power control transmission applicable for an engine with a straight shaft and having no Centrifugal Clutch (CC) supplied with engine. The items shown in exploded view FIG. 11 consists of the following reference numbers and descriptions. Housing bracket 1, Pulley cam housing 4, jackshaft 5, Driven Pulley 6 with one-way bearing, Plastic cover guard 7, Chain sprocket 8, Ball bearing 9, Ball bearing 10, Ball bearing 11, Snap ring retainer 12, Snap ring retainer 13, Flat washer 14, Bracket arm to hold plastic cover guard 15 (set of three), Washer 16, Screw 17 attached by bracket, Screw cover attach 18, Bolt 19 attached by pulley, Flat washer 20, Lock washer 21, Transmission attach bolt, set of four 22, Washer 23, Nut for sprocket 24, Key for driven pulley 25, Key for chain sprocket 26, Set screw for drive pulley 27, Spacer for pulley 28, Drive T Belt 29, Centrifugal clutch 30, Key 31, Clutch bell and drive pulley 32, Oil-lite Bushing 33, Spacer 34 One-way bearing for driven pulley 35, Snap ring retainer 36, Spacer ring 37, Key 38, Spacer for chain sprocket 39.

FIG. 12 shows the parts of a T belt power control transmission with engager system applicable for an engine with an integral Centrifugal Clutch (CC) supplied with engine. The items shown in exploded view FIG. 12 consist of the following reference #'s and descriptions. It should firstly be understood that only the items of the 4-2 engager system are called out as all other parts are the same as with FIG. 10. The Pulley Cam Housing assembly 4-2 consist of the following descriptions and reference numbers: 4-2-1 Cam Housing empty 4-2-1, Ball Bearing 4-2-2, Ball bearing 4-2-3, Shaft 4-2-4, Sliding engager assay 4-2-5, Steel ball 4-2-6, Outboard engager shaft 4-2-7, Inner race needle bearing 4-2-8-1, Outer race needle bearing 4-2-8-2, Snap ring 4-2-9, Wishbone spring 4-2-10, Bolt fastener 4-2-11, Key 4-2-12, Key 4-2-13.

In summary of above descriptions, the T belt power control system, TBPCS, includes five essential components or embodiments:

1-A.) A cast aluminum or steel housing 1 or 1-1 holding an integral centrifugal clutch bell drum and shaft driven pulley 3 to be attached to a small vertical single cylinder four-cycle engine horizontal output shaft using four-bolt holes 25. It should be clearly noted and well understood that should a T belt power control system must fit two kinds of engine output drives. One application is an engine having an integral three-shoe centrifugal clutch rotor that comes standard with the engine and the other is an engine having a straight output shaft and no centrifugal clutch is supplied with the engine. This invention can be made such as to not have the bell drum integral with the housing as reference by FIG. 4. In this case the centrifugal clutch and bell drum are affixed to the straight shaft of the engine with the T belt installed on a small drive pulley 32 solidly affixed to a bell drum riding on an Oil lite bushing or needle bearing.

2-B.) A cylindrical pulley cam lock assembly made of steel or cast aluminum; (4 or 4-1 or 4-2), holding a jackshaft is inserted in a sleeve hole in the housing plate either 1 or 1-1. The belt drive power train is used to transmit power in a step down speed ratio depending on diameter size of pulleys and application needed. It should be well noted that the pulley cam lock assembly may have a shift lever operated engager system 4-2 FIG. 5 and FIG. 12 or may not have depending on the application needed.

3-C.) When used with an engine having an integral Centrifugal Clutch Rotor the clutch bell drum 2 and shaft driven T belt pulley 29 are made integral with housing plate 1. When the engine is operating above a specified rpm usually about 1500 to 3000, the centrifugal clutch rotor on the engine engages or latches with the integral bell drum 2 and via pulley 3 transmits engine torque by way of T belt drive 29 to a larger driven pulley 6 having an output drive shaft 5 with a chain drive sprocket 8-10.

4-D.) A plastic cover 7 is used to enclose the T Belt drive mechanisums. It is held on by 3 brackets and screws and serves to protect the operator from getting tangled in a live running belt.

5-E.) As applied to the driven pulley cylindrical cam lock assembly an optional engager system with sliding engagement gear 4-2-21 being controlled by the shift lever 4-2-22 that is manipulated by the external cable d and hand lever e as shown in FIG. 1, and FIG. 5.

Installation and operation: The T belt box power control system 1 is attached to the engine by four mounting bolts going to four holes 25 FIG. 6 in the engine.

The T belt power control system, TBPCS, includes in kit form all above major parts or assemblies as received by the end user in one cardboard box.

Installation step one: Decide if you want to install on an engine with an integral CC or one having a straight shaft and no CC then pick the appropriate installation kit, as shown in FIG. 11 and in FIG. 12.

Installation step two. Secure an engine with correct size matching centrifugal clutch rotor and correct bolt pattern to attach the T belt drive power control system kit you have. An instruction sheet included with said kit denotes what brand and model number engines work best. Mount the selected engine on a frame member a or vehicle of choice as denoted in FIG. 1.

Installation step three: Attach the T Belt power control system with four bolts to a pre-selected small vertical single cylinder four-cycle horizontal output shaft engine as shown in FIG. 6 having a three-shoe centrifugal clutch rotor.

Installation step three: Use spanner wrench to adjust belt tension leaving about ¼″ slack play in the belt so as to not preload the engine with a tight power train load.

Installation step four: If equipped with an engager system the shift lever 22 with steel cable 8 attached going to hand lever 9 are preinstalled at the factory for ease of installation by the end user. The work load drive chain can now be installed as required on the drive sprocket 23.

Installation step five: After installing the drive chain on sprocket 8-10 attach the plastic cover 7 to housing plate 1 or 1-1 on the three bracket legs all held in position with screws. Ref. FIG. 7.

Operation Sequencing/Relationship with an Engager System 4-2:

A needle bearing and ball bearing supported output jackshaft 15B having final drive sprocket 10-8 has a sliding engagement gear 4-2-21 moved by a pivoted lever 4-2-22 controlled by an external cable d and hand lever e This design is shown an in FIG. 5 and FIG. 12, Note: Before starting the engine the shift lever must move the sliding engager gear via a cable control to the open position so the engine may start and not have a direct path to the work related wheel or load requirement as this is the main salient feature of the engager system.

A primary drive chain sprocket 8-10 is affixed to the outboard end of the jackshaft 15B for the engine output to go to the applied driven wheel of the vehicle or stationary machine as required by the end user; The workload chain can be a standard bicycle chain or a heavier 415 size chain but not exclusively. The width of the primary drive chain sprocket teeth 8-10 can be varied to make model variations for different sizes of drive chains.

The T belt power control system (TBPCS) enables a drive chain h to operate a work load requirement such as chain wheel sprocket i shown in FIG. 1 in a step down speed ratio and thus enabling a small engine to do efficient work. A prior art chain idler g provides chain tension adjustment for the drive chain h.

The T belt power control system (TBPCS) has two available operator controlled operational modes when the engine is running:

A) Engager Closed position with engine running: When engager gears 20 & 21 are in the closed engaged position with each other this allows engine power to be transmitted via centrifugal clutch engagement to travel via centrifugal clutch rotor 12 to drive pulley 3 or 32 affixed to bell drum 2 or 32 thus turning a larger driven pulley 6. The fixed engager gear 20 attached to shaft 15A when closed with sliding engager gear 21 turns the jackshaft 15B via the key or spines it rides on thereby rotating output sprocket 23 in the locked rational direction thus driving the chain h to the work related load requirement. Shift lever 4-2-22 holds the engagement gears 4-2-20 & 4-2-21 in the closed position due to the steel cable being locked closed by lever e.

B) Engager Open position with engine running: When the end user operator has the cable control lever e in the unlocked open position the engager gears 4-2-20 and 4-2-21 have no contact with each other and no engine power is transmitted. If the work related wheel is moving, the output sprocket 23 will freewheel over run and the jackshaft 4-2-15B will not turn pulley 15. If the end user operator decides to re-engage the engine power to the closed position no matter if the vehicle is stopped or rolling the transition coupling of engager gears is made smoothly when the shift lever 4-2-22 is moved by the operator via lever e attached to control cable d It should be noted that the angled teeth on both engagement gears enhance smooth slide engagement. A compression spring holds the shift lever in the open position thus keeping the engagement gear 4-2-21 in the open position. If the vehicle is stopped the operator can adjust carburetor air fuel mixture settings at both idle and high rpm without worry of the work related wheel i turning. If need be in an emergency such as a centrifugal clutch failure to disengage at low rpm or a work related wheel bearing failure or flat tire occurring the operator can quickly disengage engine power via the engager control cable d and lever e thus disengaging the coupling of engagement gears 4-2-20 & 4-2-21.

C) Engine off, not running mode: The T belt power control system should be left in the open position when engine is off or not running in preparation for the next engine start cycle. It should be noted that the installer has an option to use a prior art cable control hand lever with an electrical switch that is capable of grounding out the engine ignition should an engine start attempt be attempted while the engager of the power control system is in the closed position. The driven pulley 6 on the engager jackshaft 4-2-15A will freewheel via a one way ball bearing 35 with sprag clutch should the work related wheel be turning by means other than engine power such as would be case if pushing the vehicle or people pedaling a bicycle or pedaling a pedal wheel boat in normal vehicle operational manual mode.

### EXAMPLE 2

A motorized tricycle is further disclosed that includes a tricycle frame, a modified or standard tricycle frame having a front wheel and two rear wheels attached thereto and a seat for people pedaling a chain wheel sprocket. A small four-cycle gasoline engine from 30 cc to 150 cc displacement is mounted in the middle of the tricycle V frame. The power control system having a centrifugal clutch drum bell and primary drive pulley to be installed as an assembly on an engine output shaft and working in conjunction with a belt drive train assembly having an integral engager system. The T belt power control system assembly is attached to an engine accessory drive mounting flange with four bolts. A drive chain attaches to the output jackshaft of the T belt power control system via a small primary drive sprocket and goes to a much larger sprocket mounted on the rear axel of the tricycle.

### EXAMPLE 3

A motorized paddle boat is further disclosed that includes a paddle boat normally found as a personal pleasure small boat incorporating one to four people seats. A small four-cycle gasoline engine is mounted to the boat framework. The small four-cycle gasoline engine from 30 cc to 200 cc displacement is mounted in the boat framework. The T belt power control system having a centrifugal clutch bell drum and primary drive pulley to be installed as an assembly on an engine output shaft and working in conjunction an integral engager system. The T belt power control assembly is attached to an engine accessory drive mounting flange with four bolts. A drive chain attaches to the output jackshaft of the T belt power control system via a small primary drive sprocket and goes to a much larger sprocket mounted on the boat paddle wheel shaft.

### EXAMPLE 4

A motorized go-cart is further disclosed as being a go-cart having four wheels on two axels, a steering wheel and seat for the operator and or passenger. A go-cart may be in many configurations and work applications to include light cargo hauling or for people transportation. A small gasoline engine is mounted to the go cart frame. A small four cycle gasoline engine from 30 cc to 200 cc displacement is mounted in the go-cart framework. The T Belt power control system having a centrifugal clutch and primary drive pulley to be installed as an assembly on an engine output shaft and working in conjunction with an integral engager system. The T belt power control assembly is attached to an engine accessory drive mounting flange with four bolts. A drive chain attaches to the output jackshaft of the power control system via a small primary drive sprocket and goes to a much larger sprocket mounted on the rear drive axle of the go-cart.

### EXAMPLE 5

A stationary engine work station can be further disclosed as work station requiring small four-cycle engine to turn an axel shaft such as would be typicality found using a circle saw to cut wood but not exclusively. A small four-cycle gasoline engine from 30 cc to 200 cc displacement is mounted on the work station frame. The T belt power control system having a centrifugal clutch and primary drive pulley to be installed as an assembly on an engine output shaft and working in conjunction with an integral engager system. The T belt power control assembly is attached to the engine accessory drive mounting flange with four bolts. A drive chain attaches to the output jackshaft of power control system via a small primary drive sprocket and goes to the intended work load requirement.

What is claimed is:

1. A T belt power transmission control system for a motorized vehicle, said power control system comprising: i) a single-piece housing attached by four bolts to a small vertical single cylinder horizontal output shaft four-cycle engine which encompasses a centrifugal clutch bell drum pulley and a T Belt driven pulley held in a cylindrical cam lock jackshaft assembly; ii) a centrifugal clutch bell housing made integral with a housing plate having an affixed small dia. timing belt pulley meshing with an automotive type timing belt to make a drive train going to a much larger driven pulley with a one-way bearing on a shaft with ball bearings is utilized to transmit power in a designed step down speed ratio but not designed exclusively to any certain or exact said speed ratio range; iii) said centrifugal clutch three-shoe rotor is attached to an engine output crankshaft, and transmits engine torque via a Timing belt to a driven pulley riding on an output jackshaft; iv) said ball bearing supported output jackshaft having one large diameter pulley with one-way bearing transmits power to an engager controlled system or if without engager system direct to a output chain sprocket; v) said driven pulley 6 having an one-way-ball bearing 35 using a sprag clutch turns freely on ball bearings in the opposite or overrun direction. vi) said engager system with sliding engagement gear is controlled by the shift lever that is manipulated by external cable and hand lever however an economy version T belt drive can omit the engager system and use a bike wheel stand instead but overall safety is compromised.

2. The T Belt power control system according to claim 1, said power control system is mounted to said engine and affixed on with four bolts to an engine accessory drive mounting flange of said engine and said engine being mounted to a frame of said vehicle, and said power control system having a drive chain to operate a work load wheel or axle.

3. The T belt power control system according to claim 1, said vehicle includes a bicycle, a tricycle, a go-cart, a paddle boat, or similar vehicles and also may include a stationary engine work station application.

4. The T belt power control system according to claim 1, said housing transmission plate can be made of other than die cast aluminum alloy should be any materials that are suitable to make said housing plate, including machined steel, plastics, or any other suitable materials that could be made available in the future due to new scientific developments.

5. The T belt power control system according to claim 1, said T Belt power control system has a sliding engagement gear option having the ability to transfer engine torque to the jackshaft when engaged with the fixed engagement gear on the final drive pulley.

6. The T Belt power control system according to claim 1, said power control system further comprising a primary drive 11T or 10T chain sprocket being affixed to the outboard end of said jackshaft for output drive source to go to applied driven wheel of vehicle or stationary machine as required by an end user.

7. The T belt power control system according to claim 1, said engine is a small four-cycle gasoline engine with displacement from 30 cc to 200 cc, with a centrifugal clutch operating or engaging above a specified engine rpm from 1300 to 3000 depending on engine type and size to be used with an intended end use application.

8. The T belt power control system according to claim 1, said engager controlled system having a shaft holding the large driven T belt pulley has a fixed engagement gear with angled teeth on the end of said shaft; inside the internal diameter (ID) of said engagement gear is a needle bearing that holds the corresponding opposite shaft and sliding movable engager gear; the sliding engagement gear with matching angled teeth rides on a separate shaft supported by a needle bearing and ball bearing which is controlled by a pivoted shift lever with an external lever cable.

9. The T belt power control system according to claim 1, the transmission housing plate is made such as to allow the use of varied size of cylindrical cam lock driven wheel assemblies as well as one with or without an engage system; this is accomplished by making a casting oversized to allow machining in different configurations.

10. The T belt power control system according to claim 1, said control system can work with a variety of engines, such as Honda GXH 50 and Huasheng 142F four cycle engines having been proven adaptable to work with said invention.

11. The power control system according to claim 2, said frame includes a standard or modified bicycle V frame, tricycle frame, boat framework, go-cart frame, and stationary engine work station frame.

12. The power control system according to claim 6, should the said primary jackshaft drive sprocket be made solid and without freewheel the driven pulley has an one-way ball bearing with sprag pawls that can accomplish the same effect as with a primary drive sprocket with a built in freewheel.

13. The T belt power control system according to claim 6, said primary drive sprocket is ten teeth to twelve teeth, and wide or narrow teeth as required by the work driven wheel application requirement chain size and size of engine used.
